(19) United States
(12) Patent Application Publication
(10) Pub. No.: US 2005/0144139 A1
(43) Pub. Date: Jun. 30, 2005

(54) Internet-based software license key

(75) Inventors: James Zhuge, Palo Alto, CA (US); Guohua Ma, Sunnyvale, CA (US); Jon Erik Seaberg, Reseda, CA (US)

Correspondence Address: BAKER & HOSTETLER LLP;Washington Square, Suite 1100, 1050 Connecticut Avenue, N.W., WASHINGTON, DC, 20036, US

(73) Assignee: Ling Dynamic Systems Ltd.

(21) Appl. No.: 10/743,881

(22) Filed: Dec. 24, 2003

(51) Int. Cl. G06F 17/60

(52) U.S. Cl. 705/59

(57) ABSTRACT

A method for enabling software to operate with hardware includes receiving a license key that has information regarding hardware configuration, software configuration, license key transaction history and license key warranty period. A software configuration is determined from the license key. It is then determined if the software configuration is within the license key warranty period. If it is the software is enabled with a time stamp based on the hardware configuration and the license warranty period.

### FIELD OF THE INVENTION

The present invention generally relates to pass code keys. More particularly, the present invention relates to pass code keys for enabling software.

### BACKGROUND OF THE INVENTION

Pass code keys are used in enabling or activating software. In some instances a manufacture may distribute software along with a pass code key. Thus, when a consumer buys a software package a pass code key will accompany the software. The user will upload the software into the users computer. During the upload process a pass code key may be requested from the software in order to properly install the software on to the users computer. The user will enter the pass code key which is supplied with the software thereby allowing the software to be properly installed to the users computer.

When a new version of software is distributed by the software vendor, the user will simply buy the new software which will include a new pass code key. The user will then upload the new software version on to the users computer. Again, during the installation of the new version of software, the user will be requested to provide the new pass code key. The user will provide this pass code key which accompanied the new version of the software thereby allowing installation of the new software version.

### SUMMARY OF THE INVENTION

The present invention is a new scheme to issue a pass code/activation code for software. A licensed key will be generated from this pass code/activation code which contains not only the information about software options and hardware configuration, but also includes a time stamp. The time information will allow for handling upgrades and expiration issues. It will also enable certain software functions for limited periods of time. There can be in different embodiments of the invention a temporary license key and a permanent license key.

In accordance with one embodiment of the present invention, a method for enabling software to operate with hardware includes receiving a license key that has information regarding hardware configuration, software configuration, license key transaction history and license key warranty period. A software configuration is determined from the license key. It is then determined if the software configuration is within the license key warranty period. If it is the software is enabled with a time stamp based on the hardware configuration and the license warranty period.

The warranty period can further indicate a time when new versions of software are not operational and/or a time when the software ceases to be operational.

The information regarding hardware configuration from the license key can further include a hardware serial number.

The enabling step can be further based on the information regarding a license key transaction history from the license key.

The license key is in some instances encrypted.

The can further include determining a hardware configuration in determining how to enable the software.

The invention in an alternate embodiment is a system that enables software to operate with hardware. The system includes a means for receiving a license key that has information regarding hardware configuration, software configuration, license key transaction history and license key warranty period; a means for determining a software configuration from the license key; a means for determining if the software configuration is within the license key warranty period; and a means for enabling the software with a time stamp based on the hardware configuration and the license warranty period.

The system can be configured so that the warranty period indicates a time when new versions of software are not operational and/or indicates a time when the software ceases to be operational.

The information regarding hardware configuration from the license key can further include a hardware serial number.

The means for enabling can be further based on the information regarding license key transaction history from the license key.

For security purposes the license key can be encrypted.

The system can further include a means for determining a hardware configuration.

The invention in another embodiment is a device that enables software to operate with hardware. The device includes an input that receives a license key having information regarding hardware configuration, software configuration, license key transaction history and license key warranty period; a software detection mechanism that determines a software configuration from the license key; and a software enabling mechanism that enables the software with a time stamp based on the hardware configuration and the license warranty period.

The warranty period can further indicate a time when new versions of software are not operational and/or a time when the software ceases to be operational.

The information regarding hardware configuration from the license key can include a hardware serial number.

The software enabling mechanism can further enable the software based on the information regarding license key transaction history from the license key.

The license key can be encrypted.

The invention can further include a hardware detection mechanism that determines a hardware configuration.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a license key.

FIG. 2 is an illustration of the steps to enable a system using a license key.

FIG. 3 is a graph showing expiration of a permanent license key.

FIG. 4 is a graph showing expiration of a temporary license key.

### DETAILED DESCRIPTION

The invention will now be described with reference to the drawing figures, in which like reference numerals refer to like parts throughout. An embodiment in accordance with the present invention provides a pass code/activation code for software. The pass code and activation code can be combined into a single license key. The license key contains information about software options, hardware configuration and a time stamp. The time stamp will allow for handling of upgrades and expiration issues.

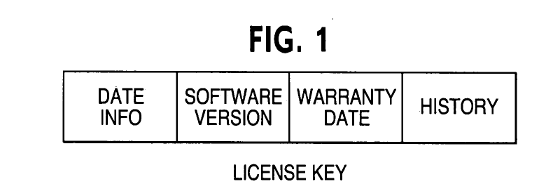

An embodiment of the present inventive apparatus is illustrated in FIG. 1. FIG. 1 is an illustration of a license key which includes data information that describes the time frame for which software code is valid, software version, warranty date information, and a history of configurations for a given serial number. A license key can be created on-line when a computer is connected with Internet access. The license key can in some embodiments of the invention include a previous pass code and activation code which is combined into a 39 digit code called a license key.

The license key system includes a flexible format, a web interface for a production department, a web interface for the customer and a back end data base. The license key format includes more room for software configuration information, the date for which the license key is first valid, the duration for which the license key is valid, the version of software for which the license key is valid and a warranty expiration date. With this information embedded in the license key there is much more control over the life and the use of the software as well as the implementation of the software.

By using Internet technologies to generate license keys for customers, production departments and OEM partners can use vendor's websites to configure each unit that is shipped to a customer. The configuration can be stored in a data base for later retrieval. The customer can also use the website to view current unit configurations, generate license keys and view license key generation histories.

There are generally two types of license keys that can be generated. A temporary license key and a permanent license key. A temporary license key only works for a period of time that is defined. For example a sixty day license key would enable a user to use a software for 60 days. At the expiration of the sixty day period, the software is no longer operational with the temporary license key. Thus after the expiration date, the license key will not work with the software. This function is designed for software renting, loaner unit, etc.

There is also a permanent license key. The permanent license key will work forever for any software released before the warranty period. For example an eighteen month warranty period would enable a user to use any version of a particular piece of software for eighteen months. After the eighteen month warranty date expires, the license key will not be able to be used with any versions of the software released after the eighteen month warranty period. The license key will however enable a user to use older versions of the software. This approach will handle the warranty and upgrade issue.

For example, if a key is generated on Jan. 1, 2004 and the warranty period is set as eighteen months, this key will work forever for any software released before Jun. 30, 2005. The software released after Jun. 30, 2005 will require a new key.

In some instances a normal customer shipment will use a permanent license key with a warranty set at eighteen months. A time period of eighteen months may be used in the case where the software warranty period is listed as twelve months. After the license key is generated, it will take some time to get the system finally installed at the customers site. This assumes that it would take less than six months to this. Thus the six months plus the twelve months equals a total of eighteen months which should cover the warranty period for the software.

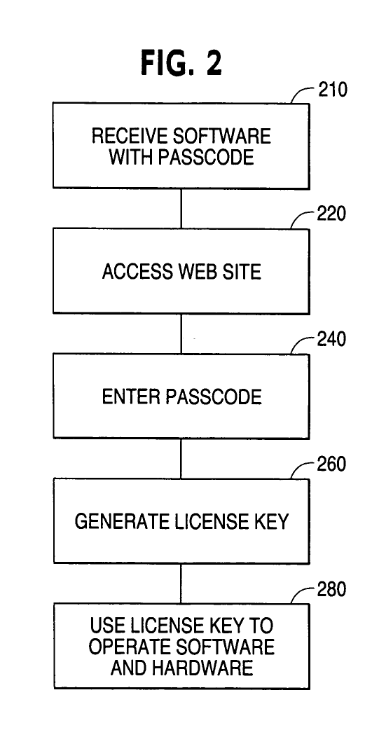

FIG. 2 illustrates the process a customer would go through in order to receive and use a software license key. Initially the customer will contact the software vendor requesting a version of software. The software vendor will receive the order from the customer, remove the unit from inventory and enter the serial number from the unit hardware configuration and software configuration into the license key system. The system will generate a login code to be associated with the serial number. In step 210 the customer will receive an order shipped from the vendor. The vendor will have shipped and packaged the unit along with a packing slip which should contain the serial number, login code and instructions on how to obtain the software license key from a website.

Once the software is received with the pass code, the customer will set up the hardware and install the software. The customer will then open up a web browser and navigate to the software vendor website. The customer will go to the website as illustrated in step 220 and provide a serial number and login code along with a pass code as illustrated in step 240. The web server will serve a page that contains the hardware configuration, current software configuration, license key transaction history, license key warranty expiration information, and a link to generate a new license key for the serial number. To get a license key, the user will click the generate license key as illustrated in step 260. A new screen will appear with the new software license key. In step 280 the customer will copy the license key from the web page to the software to enable the hardware and software features.

In the event that an upgrade is needed a customer would call the software vendors representative and request an upgrade. If the upgrade does not require a shipment of hardware with a serial number, the changes made to the configuration to upgrade or downgrade the software configuration. The customer would then access the software vendors website through a web browser and navigate to the appropriate section for upgrades or downgrades. The customer will provide their serial number and password from the packing slip in the event that new hardware is required. Otherwise the customer would just provide their own serial number. The web server would then serve a page that contains the customers current hardware configuration, software configuration, license key transaction history, license key/warranty expiration information and a link to generate a new license key. To get the license key the user would click the generate license key link and a new screen would appear with the new software license key. As stated in previous examples the customer would simply copy the license key from the web page to the vendors software to enable the hardware and software features which were selected.

In another embodiment of the invention an OEM configuration can be used in which the user will have access to upgrade and downgrade software, hardware, tools and configurations to a certain degree. In these instances the OEM will have their own user name for the configuration tool. The configuration tool will be set up to allow the OEM to configure a set of limited hardware and software which will be determined by a contract in some instances between the software vendor and the OEM. The OEM will then determine how to deliver the license key to their customer.

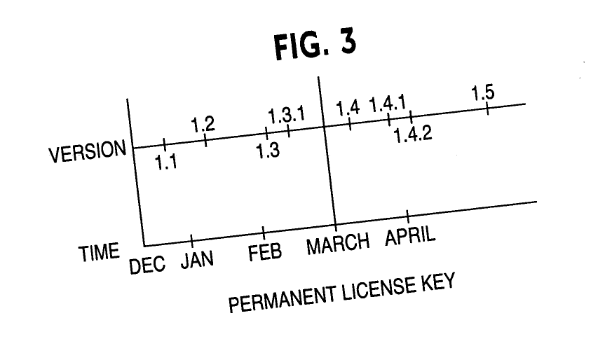

FIG. 3 is an illustration of how a permanent license key may work in some situations. For example, if the license key forwarded to a user expired in March, the user would have access to versions 1.1, 1.2, 1.3 and 1.31. However, after the March expiration date the user would not have access to versions 1.4, 1.41, 1.42 or 1.5.

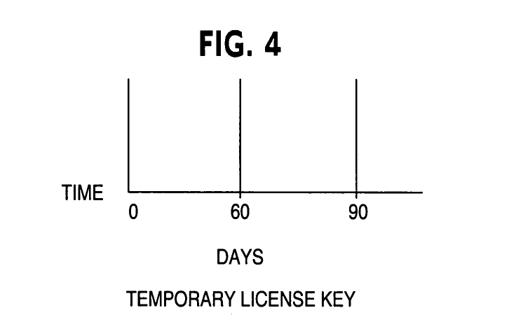

An example of a temporary license key is illustrated in FIG. 4. In FIG. 4 the temporary license key would have an expiration date of for example ninety days. Thus at the sixty day period, the software and hardware would still be operational since the license key has not expired. However once the ninety day period has expired, anything after ninety days would not work. Therefore, the software and hardware would not operate after ninety days using this temporary license key.

Some of the benefits of the above invention are that there can be enforcement for upgrades and that support for multiple payment structures can be used. These payment structures can be based on concepts such as time outs, number of uses, version control, etc. Another advantage of the invention is that reduced errors in license key generation and distribution can be realized. The user now utilizes a cut and paste action to enter license key information into the application instead of typing. This can be particular useful when trying to discern between the letter O and the number 0. Another advantage of the invention is that there is a centralized location for current and past configurations by serial number. This results in enhanced reporting for marketing. Thus the present invention is an extended use of the license key control system. From an operational standpoint the changes are that in the future the license key does not have to be provided on a hard copy of a shipping document. Instead, the user can retrieve the license key anywhere at any time from the Internet with the system serial number and log in code. The license key in some instances may contain a time limit that will help in collecting payment, renting software or creating demo software or other various other types of uses.

The many features and advantage of the invention are apparent from the detailed specification, and thus, it is intended by the dependent claims to cover all such features and advantage of the invention which fall within the true spirit and scope of the invention. Further, since numerous modifications and variations will readily occur to those skilled in the art, it is not our desire to limit the invention to the exact construction and operation illustrated and described, and accordingly, all suitable modifications and equivalents may be restored to, falling within the scope of the invention.

1. A method of enabling software to operate with hardware comprising:
receiving a license key that has information regarding hardware configuration, software configuration, license key transaction history and license key warranty period;
determining a software configuration from the license key;
determining if the software configuration is within the license key warranty period;
enabling the software with a time stamp based on the hardware configuration and the license warranty period.

2. The method as recited in claim 1 wherein the warranty period indicates a time when new versions of software are not operational.

3. The method as recited in claim 1 wherein the warranty period indicates a time when the software ceases to be operational.

4. The method as recited in claim 1 wherein the information regarding hardware configuration from the license key includes a hardware serial number.

5. The method as recited in claim 1 wherein the enabling step is further based on the information regarding license key transaction history from the license key.

6. The method as recited in claim 1 wherein the license key is encrypted.

7. The method as recited in claim 1 further comprising determining a hardware configuration.

8. A system that enables software to operate with hardware comprising:
means for receiving a license key that has information regarding hardware configuration, software configuration, license key transaction history and license key warranty period;
means for determining a software configuration from the license key;
means for determining if the software configuration is within the license key warranty period;
means for enabling the software with a time stamp based on the hardware configuration and the license warranty period.

9. The system as recited in claim 8 wherein the warranty period indicates a time when new versions of software are not operational.

10. The system as recited in claim 8 wherein the warranty period indicates a time when the software ceases to be operational.

11. The system as recited in claim 8 wherein the information regarding hardware configuration from the license key includes a hardware serial number.

12. The system as recited in claim 8 wherein the means for enabling is further based on the information regarding license key transaction history from the license key.

13. The system as recited in claim 8 wherein the license key is encrypted.

14. The system as recited in claim 8 further comprising a means for determining a hardware configuration.

15. A device that enables software to operate with hardware comprising:
an input that receives a license key having information regarding hardware configuration, software configuration, license key transaction history and license key warranty period;
a software detection mechanism that determines a software configuration from the license key;
a software enabling mechanism that enables the software with a time stamp based on the hardware configuration and the license warranty period.

16. The device as recited in claim 15 wherein the warranty period indicates a time when new versions of software are not operational.

17. The device as recited in claim 15 wherein the warranty period indicates a time when the software ceases to be operational.

18. The device as recited in claim 15 wherein the information regarding hardware configuration from the license key includes a hardware serial number.

19. The device as recited in claim 15 wherein the software enabling mechanism further enables the software based on the information regarding license key transaction history from the license key.

20. The device as recited in claim 1 wherein the license key is encrypted.

21. The device as recited in claim 1 further comprising a hardware detection mechanism that determines a hardware configuration.
